(19) United States
(12) Patent Application Publication
(10) Pub. No.: US 2006/0097974 A1
(43) Pub. Date: May 11, 2006

(54) Driver for driving color-type display apparatus including small-sized partial image memory

(75) Inventors: Yoshiharu Hashimoto, Kawasaki-shi (JP); Masayuki Kumeta, Kawasaki-shi (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KAWASAKI (JP)

(21) Appl. No.: 11/268,496

(22) Filed: Nov. 8, 2005

(30) Foreign Application Priority Data
Nov. 8, 2004 (JP) 2004-323129

(51) Int. Cl. G09G 3/36

(52) U.S. Cl. 345/98

(57) ABSTRACT

In a driver for driving a color-type display apparatus capable of displaying a partial display area of a display panel, where each pixel is formed by at least three color dots, a partial image memory is adapted to store video data for each pixel of the partial display area, and a color designating circuit is adapted to designate a color of letters of the partial display area designated by the video data.

### BACKGROUND OF THE INVENTION

1. Field of the Invention

The present invention relates to a driver for driving a color-type display apparatus such as a color-type liquid crystal display (LCD) apparatus or a color-type organic or inorganic electroluminescence (EL) apparatus, including a partial image memory.

2Description of the Related Art

LCD apparatuses are lower in power consumption, lighter in weight and thinner in size, and therefore, have been applied to mobile telephone apparatuses.

Particularly, since mobile telephone apparatuses are powered by batteries, the reduction of power consumption is indispensable. On the other hand, since mobile telephone apparatuses have increased color depth, more fine-structured, higher quality of display and higher speed of image motion, the power consumption has been increased.

In order to reduce the power consumption of a color-type LCD apparatus in a state where no speech and no key operation are carried out while carrying out radio communication, when such a state has continued for a first predetermined time period, the backlight is made dark. Also, when such a state has continued for a second predetermined time period larger than the first predetermined time period, the backlight is turned OFF. Further, when such a state has continued for a third predetermined time period larger than the second predetermined time period, a partial display image such a clock display image is displayed in accordance with the content of a partial image memory.

In a prior art LCD apparatus, if an LCD panel is constructed by 240 rows×320 columns pixels each formed by three color dots, i.e., R(red), G(green) and B(blue), and one dot is represented by 64 (=2⁶) gradation voltages, one pixel is represented by 262144 (=64×64×64) colors. A memory for displaying the entire LCD panel includes 1382400 (=240×3×320×6) bits, which is enormous.

On the other hand, if a partial image memory is constructed by 240 rows×20 columns each formed by three color dots R, G and B, and one dot is represented by 2 (=2¹) gradation voltages so that one pixel is represented by 8 (=2×2×2) colors, the partial image memory is adapted to store video data for each dot and therefore, the partial image memory includes 14400 (=240×3×20×1) bits, which is very small (see: JP-2003-015609). This will be explained later in detail.

In the above-described prior art LCD apparatus, however, since video data is stored for each dot, the partial image memory is still large in size, so that the driver for driving a color-type display apparatus is high in manufacturing cost and high in power consumption.

The same problem may occur in other color-type display apparatuses such as an organic EL apparatus.

### SUMMARY OF THE INVENTION

It is an object of the present invention to provide a driver for driving a color-type display apparatus including a small-sized partial image memory, thus decreasing the manufacturing cost and the power consumption.

According to the present invention, in a driver for driving a color-type display apparatus capable of displaying a partial display area of a display panel, where each pixel is formed by at least three color dots, a partial image memory is adapted to store video data for each pixel of the partial display area, and a color designating circuit is adapted to designate a color of letters of the partial display area designated by the video data. The above-mentioned video data is 1-bit data, for example. Thus, the size of the driver can be decreased.

### BRIEF DESCRIPTION OF THE DRAWINGS

The present invention will be more clearly understood from the description set forth below, as compared with the prior art, with reference to the accompanying drawings, wherein:

FIG. 1 is a diagram for showing a partial image of a color-type LCD apparatus;

FIG. 2 is a diagram illustrating the content of a partial image memory in the prior art;

FIG. 3 is a diagram illustrating the content of the partial image memory according to the present invention;

FIG. 4 is a block circuit diagram illustrating an embodiment of the color-type LCD apparatus according to the present invention;

FIG. 5 is a detailed block circuit diagram of a first example of the data line driver of FIG. 4;

FIG. 6 is a detailed circuit diagram of a first example of the color setting register and the color selecting circuit of FIG. 5;

FIG. 7A is a diagram showing examples of the contents of the color elements Ra, Ga and Ba of FIG. 6;

FIG. 7B is a diagram showing examples of the content of the color element Ua of FIG. 6;

FIG. 8 is a detailed circuit diagram of a second example of the color setting register and the color selecting circuit of FIG. 5;

FIG. 9 is a detailed circuit diagram of a third example of the color setting register and the color selecting circuit of FIG. 5;

FIG. 10 is a detailed circuit diagram of the gamma generating circuit of FIG. 5;

FIG. 11 is a detailed circuit diagram of the D/A converter and the selector circuit of FIG. 5;

FIG. 12 is a circuit diagram of a second example of the data line driver of FIG. 4; and

FIG. 13 is a detailed circuit diagram of the sample/hold circuit of FIG. 12.

### DESCRIPTION OF THE PREFERRED EMBODIMENT

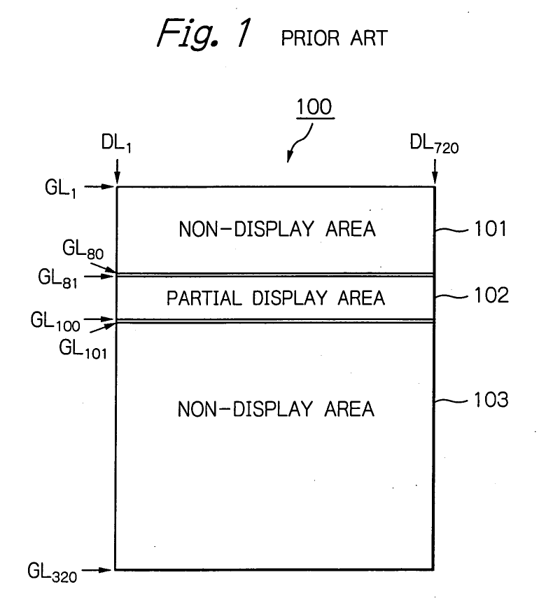

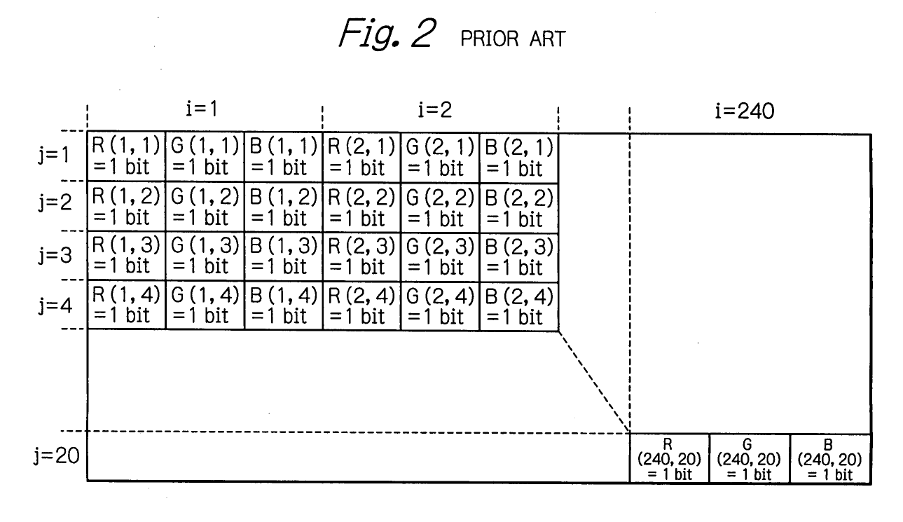

Before the description of the preferred embodiment, the panel of a prior art LCD apparatus will be explained with reference to FIGS. 1 and 2.

In FIG. 1, a panel 100 is constructed by 240 rows×320 columns pixels each formed by three color dots, i.e., R(red), G(green) and B(blue) defined by 720 (=240×3) data lines (or signal lines) DL₁ to DL₇₂₀ and 320 gate lines (or scan lines) GL₁ to GL₃₂₀. Also, one dot is represented by 64 (=2⁶) gradation voltages, so that one pixel is represented by 262144 (=64×64×64) colors.

The panel 100 is divided into a non-display area 101 of 240 rows×80 columns pixels each formed by three color dots defined by the data lines DL₁ to DL₇₂₀ and the gate lines GL₁ to GL₈₀, a partial display area 102 of 240 rows×20 columns pixels each formed by three color dots defined by the data lines DL₁ to DL₇₂₀ and the gate lines GL₈₁ to GL₁₀₀, and a non-display area 103 of 240 rows×220 columns pixels each formed by three color dots defined by the data lines DL₁ to DL₇₂₀ and the gate lines GL₈₁ to GL₃₂₀. That is, the partial display area 102 is sandwiched by the non-display areas 101 and 103. The non-display areas 101 and 103 are white in the case of a normally-white LCD apparatus, and black in the case of a normally-black LCD apparatus.

In order to reduce the power consumption, if the partial display area 102 displays letters such as “1/1 (Sun) 7:00”, the background of the partial display area 102 and the non-display areas 101 and 103 are white or black.

One dot is formed by one thin film transistor and one liquid crystal cell.

In FIG. 2, which illustrates the content of a partial image memory (RAM) for displaying the partial display area 102 of FIG. 1, since each pixel is formed by three collar dots such as R(1, 1), G(1, 1) and B(1, 1) where one dot is represented by 2 (=2¹) gradation voltages, one pixel is represented by 8(=2×2×2) colors. Thus, the partial image memory of FIG. 2 includes 14400 (=240×3×20×1) bits. In FIG. 2, note that “i” designates a row number and “j” designates a column number.

In the partial image memory of FIG. 2, however, since video data is stored for each dot (R, G and B dots), the partial image memory of FIG. 2 is still large, so that the driver therefor is high in manufacturing cost and high in power consumption.

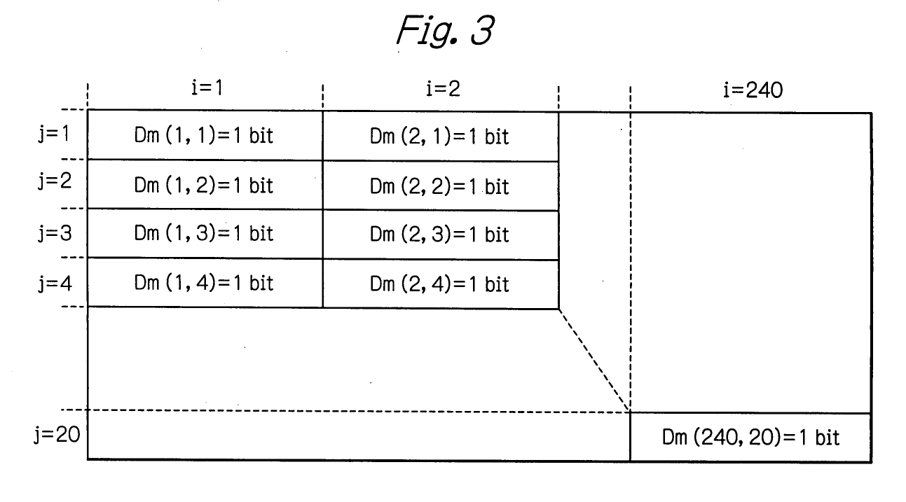

In FIG. 3, which illustrates the content of a partial image memory (RAM) according to the present invention, since each pixel is formed by one bit such as Dm (1, 1), i.e., 2(=2¹) gradation voltages, one pixel is represented by 2 colors. Thus, the partial image memory of FIG. 3 includes 4800 (=240×1×20×1) bits and therefore, is smaller in size by three times as compared with the partial image memory of FIG. 2. As a result, the driver therefor can be low in manufacturing cost and low in power consumption.

In the partial image memory of FIG. 3, although the number of colors in each pixel is decreased as compared with that of FIG. 2, the number of colors can be substantially increased by providing a color setting register and a color selecting circuit. In this case, since the color setting register and the color selecting circuit is provided commonly for all the pixels, the addition of the color setting register and the color setting circuit hardly increases the size of the data driver. The color setting register and the color setting circuit will be explained later in detail.

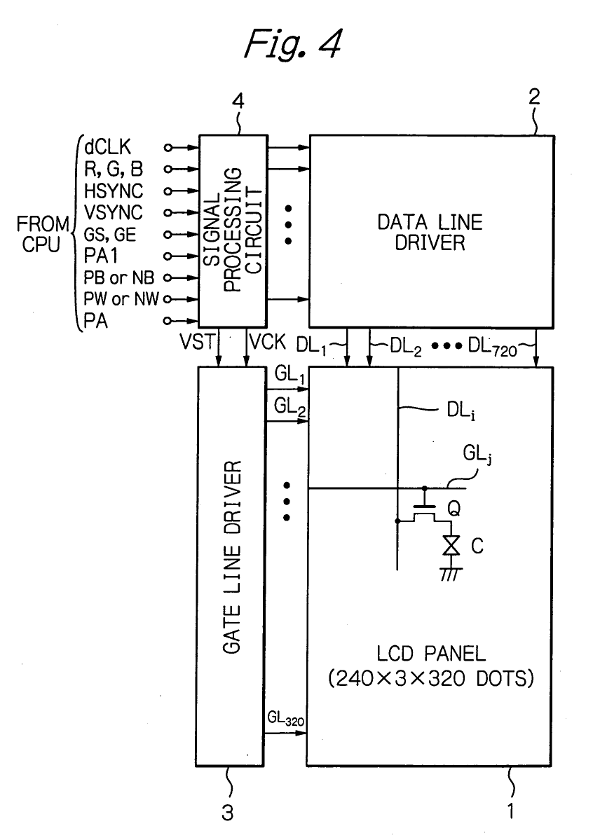

In FIG. 4, which illustrates an embodiment of the LCD apparatus according to the present invention, reference numeral 1 designates an LCD panel having 240 rows×320 columns pixels each formed by three color dots, i.e., R (red), G(green) and B(blue). Therefore, the LCD panel 1 includes 230400 dots located at 720 (=240×3) data lines (or signal lines) DL₁, DL₂ . . . , DL₇₂₀ and 320 gate lines (or scan lines) GL₁, GL₂ . . . , GL₃₂₀. One dot is formed by one thin film transistor Q and one liquid crystal cell C. For example, if one dot is represented by 64 gradation voltages, one pixel is represented by 262144 (=64×64×64) colors.

In order to drive the data lines DL₁, DL₂ . . . , DL₇₂₀, a data line driver 2 is provided along a horizontal edge of the LCD panel 1. On the other hand, in order to drive the gate lines GL₁, GL₂ . . . , GL₃₂₀, a gate line driver 3 is provided along a vertical edge of the LCD panel 1.

A signal processing circuit 4 receives a dot clock signal dCLK, video signals R, G and B, a horizontal synchronization signal HSYNC, a vertical synchronization signal VSYNC, partial display area start and end values GS and GE, gamma set values PB or NB and PW or NW, a partial display signal PA, and the like from a central processing unit (CPU) of a mobile telephone apparatus, and generates a 1-bit video signal Dx1, a strobe signal STB1, data signals Ra, Ga, Ba and Ua, a partial display area signal PA1, a horizontal start signal HST, a horizontal clock signal HCK, an 18-bit video signal Dx2, a strobe signal STB2, gamma set value signals PB or NB and PW or NW and a partial display signal PA for the data line driver 2, and a vertical start signal VST and a vertical clock signal VCK for the gate line driver 3.

In FIG. 4, the data line driver 2 passes the horizontal start signal HST therethrough in synchronization with the horizontal clock signal HCK, to drive the data lines DL₁, DL₂, . . . , DL₇₂. Also, the gate line driver 3 passes the vertical start signal VST therethrough in synchronization with the vertical clock signal VCK, to drive the gate lines GL₁, GL₂, . . . , GL₃₂₀.

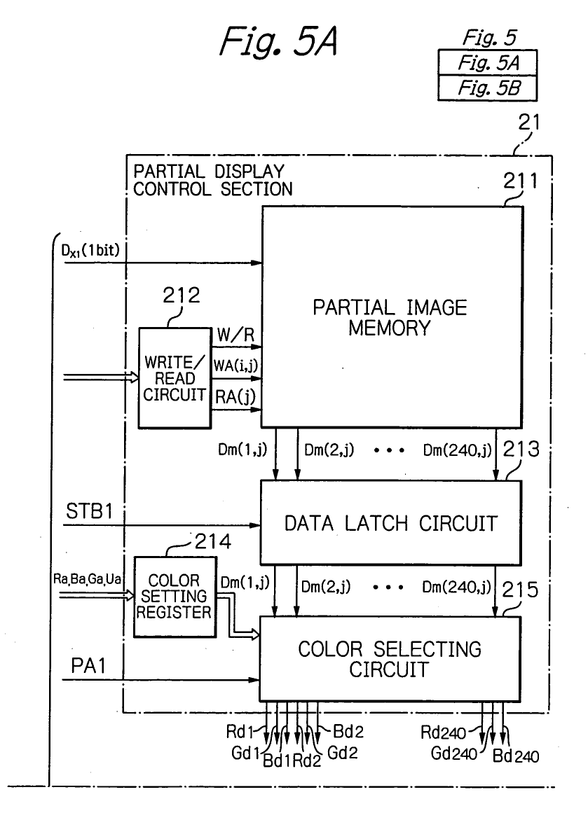

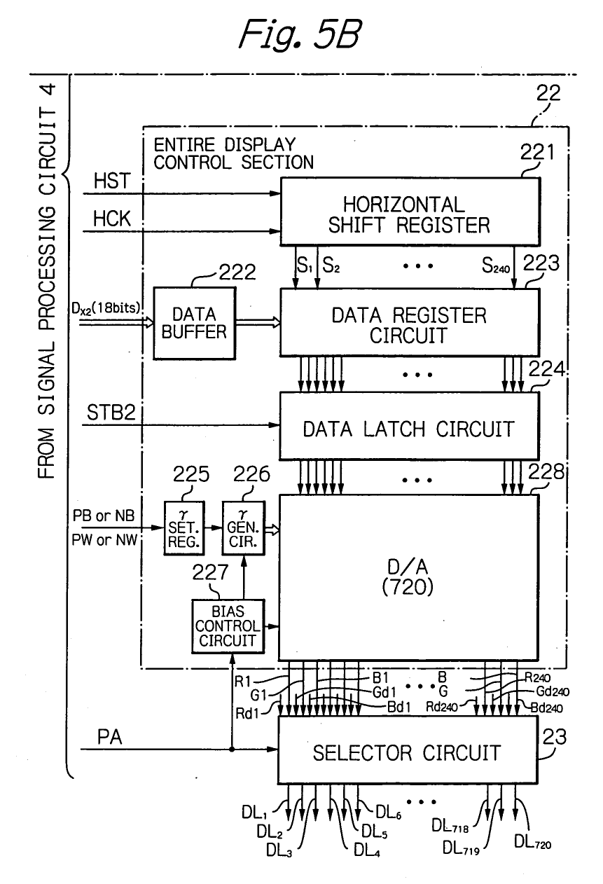

In FIG. 5, which is a detailed block circuit diagram of a first example of the data line driver 2 of FIG. 4, the data line driver 2 is constructed by a partial display control section 21, an entire display control section 22 and a selector circuit 23 for switching the partial display control section 21 and the entire display section 22 in accordance with the partial display signal PA. For example, when PA =“1”, the partial display control section 21 is selected by the selector circuit 23 and is connected to the data lines DL₁, DL₂, . . . , DL₇₂₀. On the other hand, when PA =“0”, the entire display control section 22 is selected by the selector circuit 23 and is connected to the data lines DL₁, DL₂, . . . , DL₇₂₀.

The partial display control section 21 is explained next in detail.

The partial display control section 21 is constructed by a partial image memory (RAM) 211 having a capacity of 240×20 bits, for example, as illustrated in FIG. 3, a write/read circuit 212, a data latch circuit 213, a color setting register 214 and a color selecting circuit 215.

The write/read circuit 212 causes a write/read signal W/R to be high to perform a 1-bit write operation upon the partial display memory 211, so that 1-bit data Dx1 is written into a bit of the partial display memory 211 designated by a write address WA(i, j) generated from the write/read circuit 212. On the other hand, the write/read circuit 212 causes the write/read signal W/R to be low to perform a one-column read operation upon the partial display memory 211 so that a j-th column line (240 bits) of the partial image memory 211 designated by a read address R (j) is read out as data signals Dm(1, j), Dm(2, j), . . . , Dm(240, j).

The data signals Dm(1, j), Dm(2, j), . . . , Dm(240, j) read out of the partial display memory 211 corresponding to one gate line are latched by a data latch circuit 213 in synchronization with a strobe signal STB1.

The color selecting circuit 215 receives the data signals Dm(1, j), Dm(2, j), . . . , Dm(240, j) from the data latch circuit 213 to generate data signals Rd1, Gd1, Bd1, Rd2, Gd2, Bd2; . . . , Rd240, Gd240, Bd240 in accordance with video signals Ra, Ga, Ba and Ua of the color setting register 214 and the partial display area signal PA1. The color setting register 214 and the color selecting circuit 215 will be explained later in detail.

The entire display control section 22 is explained next in detail.

The entire display control section 22 is constructed by a horizontal shift register 221, a data buffer 222 for storing 18-bit video data Dx2, a data register circuit 223, a data latch circuit 224, a gamma setting register 225, a gamma generating circuit 226, a bias control circuit 227, and a digital/analog (D/A) converter 228.

The horizontal shift register 221 shifts the horizontal start signal HST in synchronization with the horizontal clock signal HCK, to sequentially generate sample/hold signals S₁, S₂, . . . , S₂₄₀.

The data register circuit 223 latches the video signals Dx2(18 bits) formed by R(6 bits), G(6 bits) and B(6 bits) in synchronization with the sample/hold signals S₁, S₂, . . . , S₂₄₀, to generate video signals R1, G1, B1, R2, G2, B2, . . . , R240, G240, B240, respectively. The video signals R1, G1, B1, R2, G2, B2, . . . , R240, G240, B240 are supplied to the data latch circuit 224.

The data latch circuit 224 latches the video signals R1, G1, B1; R2, G2, B2, . . . , R240, G240, B240 of the data register 222 in synchronization with a strobe signal STB2.

The gamma setting register 225, the gamma generating circuit 226, the bias control circuit 227 and the D/A converter 228 will be explained later in detail.

The selector circuit 23 will be explained later in detail.

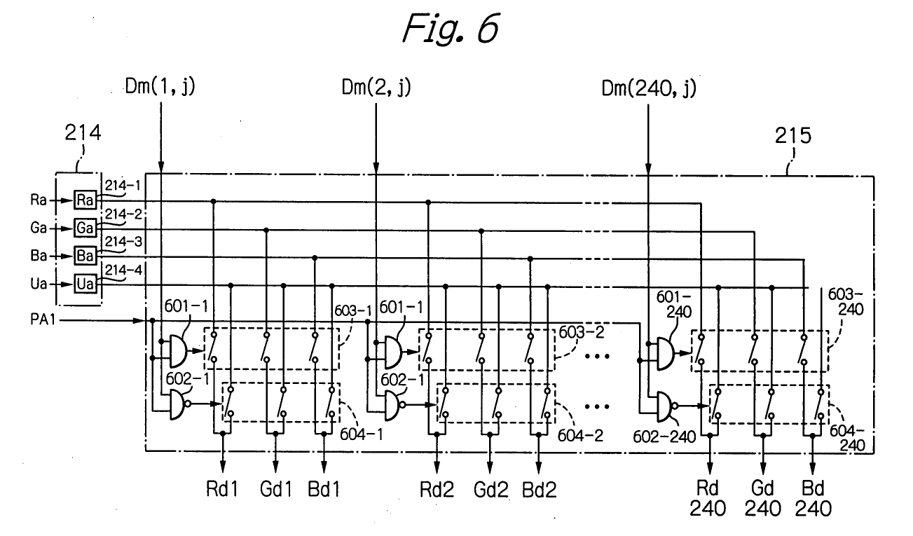

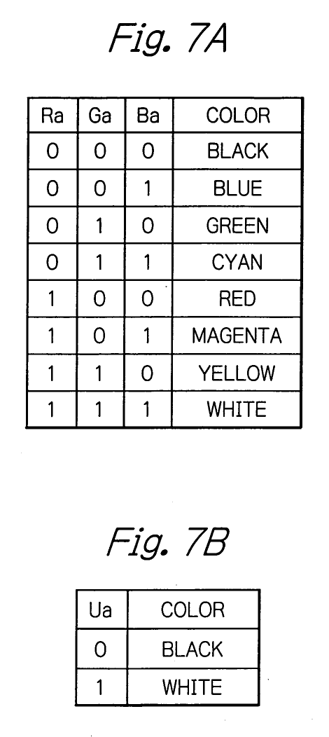

In FIG. 6, which is a detailed circuit diagram of the color setting register 214 and the color selecting circuit 215 of FIG. 5, the color setting register 214 is constructed by four elements 214-1, 214-2, 214-3 and 214-4 for storing bits Ra, Ga, Ba and Ua, respectively. In this case, the bits Ra, Ga and Ba selected from the colors of FIG. 7A define the color of displayed letters of the partial display area, and the bit Ua selected from the colors of FIG. 7B defines the color of the background of the partial display area. In this case, if Ua=0, (Ra, Ga, Ba) is not (0, 0, 0), and if Ua=1, (Ra, Ga, Ba) is not (1, 1, 1). Also, in the case of a normally-white type LCD apparatus, Ua is made to be “1” (white). On the other hand, in the case of a normally-black type LCD apparatus, Ua is made to be “0” (black). This would decrease the power consumption.

The color selecting circuit 215 is constructed by AND circuits 601-1, 601-2, . . . , 601-240 for receiving the data signals Dm(1, j), Dm(2, j), , Dm(240, j), respectively, as well as the partial display area signal PA1, NAND circuits 602-1, 602-2, . . . , 602-240 for receiving the data signals Dm(1, j), Dm(2, j), . . . , Dm(240, j) as well as the partial display area signal PA1, switch circuits 603-1, 603-2, . . . , 603-240 connected to the color elements 214-1, 214-2 and 214-3, and switch circuits 604-1, 604-2, . . . , 604-240 connected to the color element 214-4.

The switch circuits 603-1, 603-2, . . . , 603-240 are controlled by output signals of the AND circuits 601-1, 601-2, 601-240, respectively, and the switch circuits 604-1, 604-2, . . . , 604-240 are controlled by output signals of the NAND circuits 602-1, 602-2, . . . , 602-240, respectively.

Thus, if PA1=“1” (partial display area), the AND circuits 601-1, 601-2, . . . , 601-240 are enabled so that the switch circuits 603-1, 603-2, . . . , 603-240 are turned ON in accordance with the data signals Dm(1, j), Dm(2, j), . . . , Dm(240, j). Simultaneously, the NAND circuits 602-1, 602-2, . . . , 602-240 are disabled so that the switch circuits 604-1, 604-2, . . . , 604-240 are turned OFF. Therefore, if Dm(1, j)=“1” (letters), the switch circuits 603-1 and 604-1 are turned ON and OFF, respectively, so that (Rd1, Gd1, Bd1) is equal to (Ra, Ga, Ba), thus making the color of pixel (1, j) to be its corresponding one as illustrated in FIG. 7A. On the other hand, if Dm(1, j)=“0” (background), the switch circuit 603-1 and 604-1 are turned OFF and ON, respectively, so that (Rd1, Gd1, Bd1) is equal to Ua(black or white), thus making the color of pixel (1, j) to be its corresponding one as illustrated in FIG. 7B.

On the other hand, if PA1=“0” (non-display area), the AND circuits 601-1, 601-2, . . . , 601-240 are disabled so that the switch circuits 603-1, 603-2, . . . , 603-240 are turned OFF. Simultaneously, the NAND circuits 602-1, 602-2, . . . , 602-240 are enabled so that the switch circuits 604-1, 604-2, . . . , 604-240 are turned ON. Therefore, (Rd1, Gd1, Bd1) is equal to Ua(black or white), thus making the color of pixel (1, j) to be its corresponding one as illustrated in FIG. 7B.

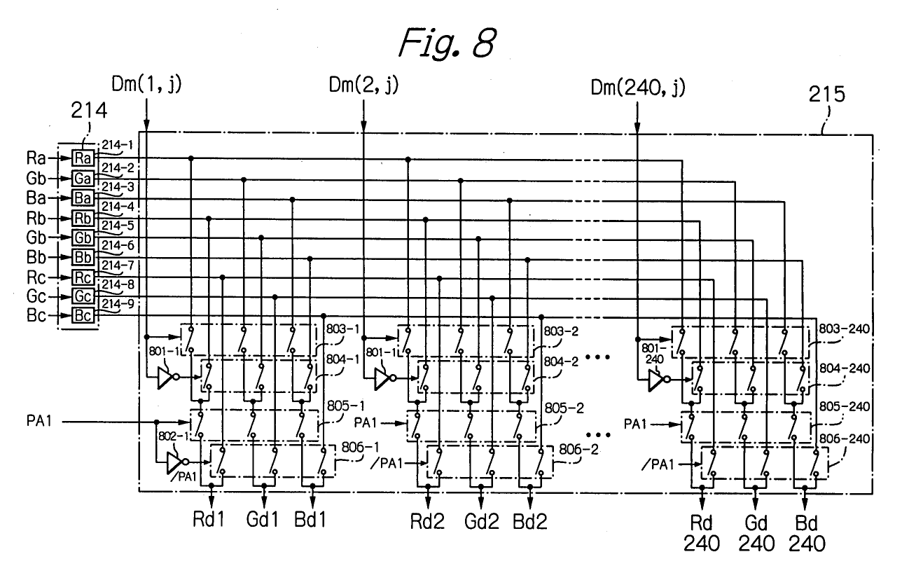

In FIG. 8, which is a modification of the color setting register 214 and the color selecting circuit 215 of FIG. 6, the color setting register 214 is constructed by nine elements 214-1, 214-2, 214-3, 214-4, 214-5, 214-6, 214-7, 214-8 and 214-9 for storing bits Ra, Ga, Ba, Rb, Gb, Bb, Rc, Gc and Bc, respectively. In this case, the bits Ra, Ga and Ba define the color of displayed letters of the partial display area, and the bits Rb, Gb and Bb define the color of the background of the partial display area, and the bits Rc, Gc and Bc define the color of the non-display area. For example, (Ra, Ga, Ba), (Rb, Gb, Bb) and (Rc, Gc, Bc) are different from each other and are selected from the colors as illustrated in FIG. 7A. This would increase the power consumption.

The color selecting circuit 215 is constructed by inverters 801-1, 801-2, . . . , 801-240 for receiving the data signals Dm(1, j), Dm(2, j), . . . , Dm(240, j), respectively, an inverter 802 for receiving the partial display area signal PA1, switch circuits 803-1, 803-2, . . . , 803-240 connected to the color elements 214-1, 214-2 and 214-3, switch circuits 804-1, 804-2, . . . , 804-240 connected to the color elements 214-4, 214-5 and 214-6, switch circuits 805-1, 805-2, . . . , 805-240 connected to the switch circuits 804-1, 804-2, . . . , 804-240, respectively, and switch circuits 806-1, 806-2, . . . , 806-240 connected to the color elements 214-7, 214-8 and 214-9.

The switch circuits 803-1, 803-2, . . . , 803-240 are controlled by the data signals Dm(1, j), Dm(2, j), . . . , Dm(240, j), respectively; the switch circuits 804-1, 804-2, . . . , 804-240 are controlled by inverted signals of the data signal Dm(1, j), Dm(2, j), . . . , Dm(240, j); the switch circuits 805-1, 805-2, . . . , 805-240 are controlled by the partial display area signal PA1; and the switch circuits 806-1, 806-2, . . . , 806-240 are controlled by an inverted signal/PA1 of the partial display area signal PA1.

Thus, if PA1=“1” (partial display area), the switch circuits 805-1, 805-2, . . . , 805-240 are turned ON, and the switch circuits 806-1, 806-2, . . . , 806-240 are turned OFF.

Additionally, one of the switch circuits 803-1 and 804-1, one of the switch circuits 803-2 and 804-2, . . . , and one of the switch circuits 803-240 and 804-240 are turned ON in accordance with the data signals Dm(1, j), Dm(2, j), . . . , Dm(240, j). Therefore, if Dm(1, j)=“1” (letters), the switch circuits 803-1 and 804-1 are turned ON and OFF, respectively, so that (Rd1, Gd1, Bd1) is equal to (Ra, Ga, Ba) of FIG. 7A, thus making the color of pixel (1, j) to be its corresponding one as illustrated in FIG. 7A. On the other hand, if Dm(1, j)=“0” (background), the switch circuits 803-1 and 804-1 are turned OFF and ON, respectively, so that (Rd1, Gd1, Bd1) is equal to (Rb, Gb, Bb), thus making the color of pixel (1, j) to be its corresponding one as illustrated in FIG. 7A.

On the other hand, if PA1=“0” (non-display area), the switch circuits 805-1, 805-2, . . . , 805-240 are turned OFF, and the switch circuits 806-1, 806-2, . . . , 806-240 are turned ON. Even in this case, the switch circuits 803-1, 803-2, . . . , 803-240 and the switch circuits 804-1, 804-2, . . . , 804-240 are turned ON and OFF in accordance with the data signals Dm(1, j), Dm(2, j), , Dm(240, j); however, since the switch circuits 805-1, 805-2, . . . , 805-240 are turned OFF, the operation of the switch circuits 804-1, 804-2, . . . , 804-240 does not affect the values (Rd1, Gd1, Bd1), (Rd2, Gd2, Bd2), . . . , (Rd240, Gd240, Bd240). Therefore, (Rd1, Gd1, Bd1) is equal to (Rc, Gc, Bc), thus making the color of pixel (1, j) to be its corresponding one as illustrated in FIG. 7A.

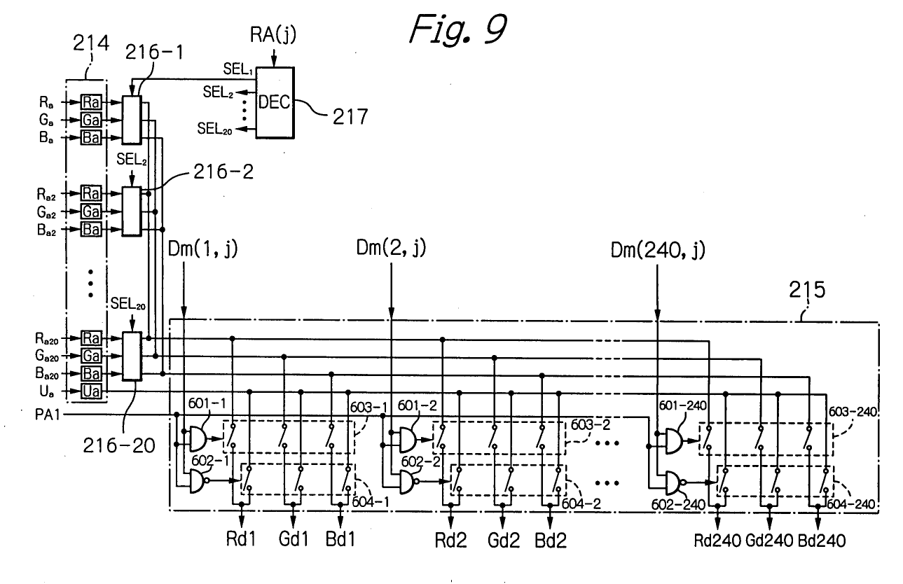

In FIG. 9, which is a modification of the color setting register 214 of FIG. 6, the color setting circuit 214 is constructed by color elements Ra1, Ga1, Ba1 for the 1st column line (j=1) of the partial image memory 211 corresponding to the gate line GL₈₁ of FIG. 1, color elements Ra2, Ga2, Ba2 for the 2nd column line (j=2) of the partial image memory 211 corresponding to the gate line GL₈₂ of FIG. 1, , and color elements Ra20, Ga20, Ba20 for the 20th column line (j=20) of the partial image memory 211 corresponding to the gate line GL₁₀₀ of FIG. 1. In this case, (Ra1, Ga1, Ba1), (Ra2, Ga2, Ba2), . . . , (Ra20, Ga20, Ba20) are selected from the colors of FIG. 7A.

In FIG. 9, switch circuits 216-1, 216-2, . . . , 216-20 connected to the color elements (Ra1, Ga1, Ba1), (Ra2, Ga2, Ba2), . . . , (Ra20, Ga20, Ba20), respectively, and a decoder 217 for selecting one of the switch circuits 216-1, 216-2, . . . , 216-20 are added. In this case, since the decoder 217- sequentially selects the switch circuits 216-1, 216-2, . . . , 216-20 in accordance with the read address RA (=j) for the partial image memory 211, the colors of letters of the partial display area can be changed for every gate line (scan line).

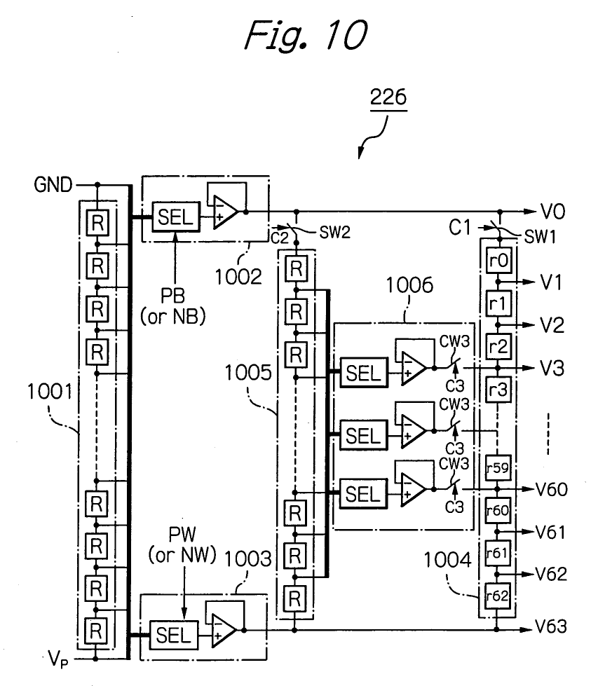

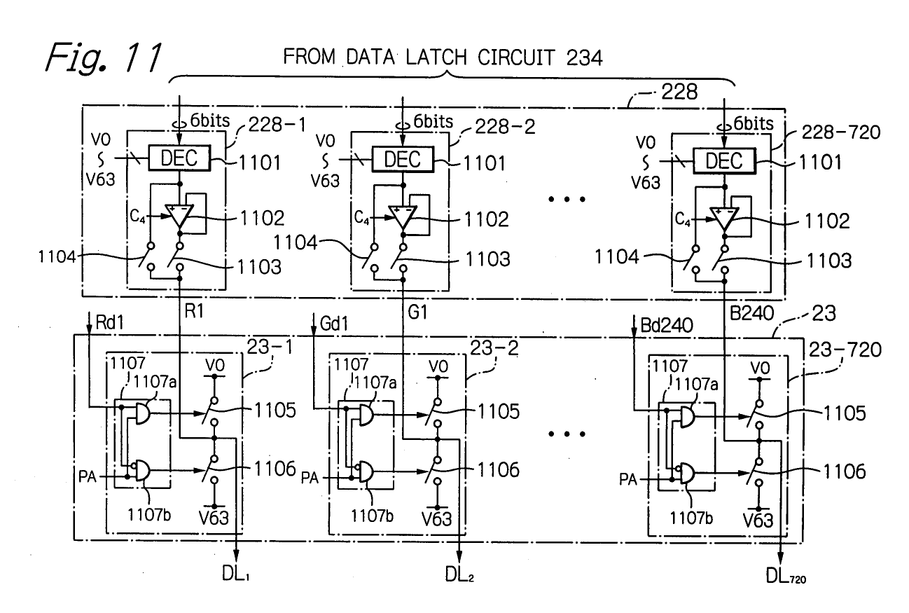

In FIG. 10, which is a detailed block circuit diagram of the gamma generating circuit 226 of FIG. 5, the gamma generating circuit 226 generates 64 (=26) gradation voltages V0 to V63 and transmits them to each D/A section of the D/A converter 228.

The gamma generating circuit 226 includes a resistance string 1001 formed by a plurality of resistors having the same resistance value. A plurality of voltages divided between GND and Vₚ are applied to selector circuits 1002 and 1003. The selector 1002 selects one of the voltages in accordance with a selection signal PB for minimizing the transmittance of liquid of a positive gamma correction (or a selection signal NB for minimizing the transmittance of liquid of a negative gamma correction) from the gamma setting register 225 to generate the voltage V0. Also, the selector 1003 selects one of the voltages in accordance with a selection signal PW for maximizing the transmittance of liquid of the positive gamma correction (or a selection signal NW for maximizing the transmittance of liquid of the negative gamma correction) from the gamma setting register 225 to generate the voltage V63.

The gamma generating circuit 226 also includes a resistance string 1004 formed by resistors r0, r1, . . . , r62 which generates the voltages V1, V2, . . . , V62. In this case, the total resistance of the resistance string 1004 is smaller than that of the resistance string 1001, so as to drive a large number of D/A sections such as 720 D/A sections of the D/A converter 228.

A resistance string 1005 formed by resistors R and a D/A converter 1006 are used for fine-adjustment of the gamma correction; however, the resistance string 1005 and D/A converter 1006 are not indispensable.

In a partial display mode (PA=“1”), only the voltages V0 and V63 are required. Therefore, in this case, the bias control circuit 226 receives the partial display control signal PA to generate control signals C1, C2 and C3 and transmit them to switches SW1, SW2 and SW3, thus powering OFF the resistance string 1004 and 1005 and the D/A converter 1006. This would decrease the power consumption. On the other hand, in an entire display mode (PA=“0”), all the voltages V0, V1, . . . , V63 are required. Therefore, in this case, the bias control circuit 226 receives the partial display control signal PA to inactivate the control signals C1, C2 and C3, thus powering ON the resistance string 1004 and 1005 and the D/A converter 1006.

In FIG. 11, which is a detailed circuit diagram of the D/A converter 228 and the selector circuit 23 of FIG. 5, the D/A converter 228 is constructed by 720 D/A sections 228-1, 228-2, . . ., 228-720 each of which includes a decoder 1101, a voltage amplifier 1102 and switches 1103 and 1104. That is, the decoder 1101 selects one of the gradation voltages V0 to V63 in accordance with one of the 6-bit video signals from the data latch circuit 234, so that the voltage amplifier 1102 amplifies-the selected one of the gradation voltages V0 to V63. In this case, during a first driving time period of one horizontal scanning period determined by the horizontal start signal HST, the switches 1103 and 1104 are turned ON and OFF, respectively, by the signal processing circuit 4 so that the selected one of the gradation voltages V0 to V63 is output via the voltage amplifier 1102 as one of the video signals R1, G1, . . . , B240. Then, in a second driving time period of the horizontal scanning period after the above-mentioned first driving time period, the switches 1103 and 1104 are turned OFF and ON, respectively, by the signal processing circuit 4 so that the selected one of the gradation voltages V0 to V63 is output directly as one of the video signals R1, G1, . . . , B240. In this case, note that the voltage amplifier 1102 is activated by a control signal C₄ from the bias control circuit 227 only during the above-mentioned driving time period, thus reducing the power consumption.

In a small sized LCD apparatus, however, note that the voltage amplifier 1102 and the switches 1103 and 1104 can be omitted, so that the selected one of the gradation voltages V0 to V63 can be always output directly as one of the video signals R1, G1, . . . , B240, thus further reducing the power consumption.

Also, the selector circuit 23 is constructed by 720 selector elements 23-1, 23-2, . . . , 23-720 each of which includes switches 1105 and 1106 controlled by a logic circuit 1107 formed by two gate circuits 1107a and 1107b. That is, when PA=“1”, the logic circuit 1107 turns ON and OFF the switches 1105 and 1106 in accordance with one of the video signals Rd1, Gd1, . . . , Bd240 from the color selecting circuit 215, so that the voltage at one of the data lines DL₁, DL₂, . . . , DL₇₂₀ becomes V0 or V63. On the other hand, when PA=“0”, the logic circuit 1107 inactivates the switches 1105 and 1107, so that the voltage at one of the data lines DL₁, DL₂, . . . , DL₇₂₀ becomes the voltage of one of the video signals R1, G1, . . . , B240.

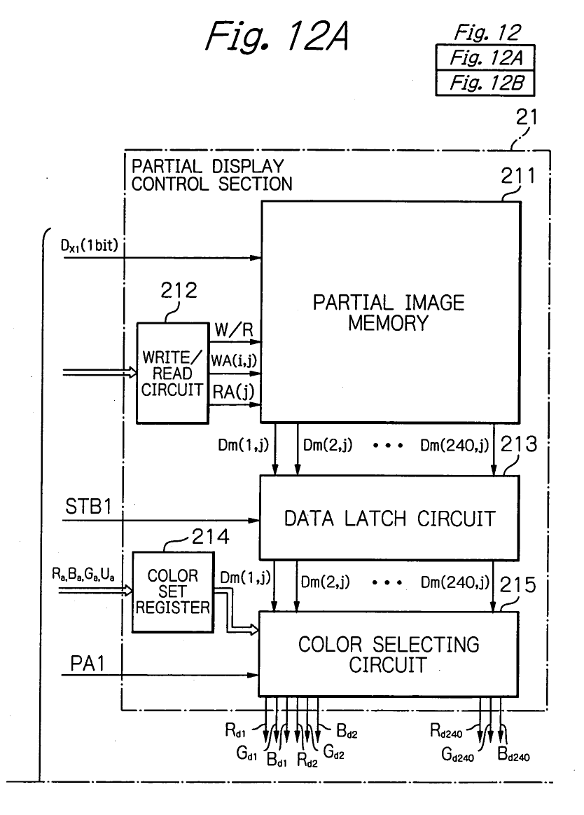

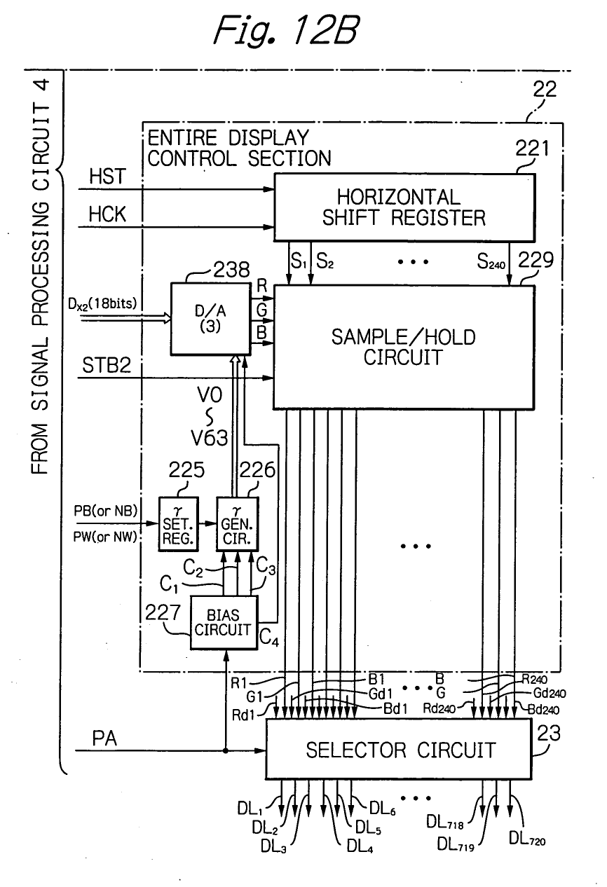

In FIG. 12, which illustrates a second example of the data line driver of FIG. 4, the data buffer 222 of FIG. 5 is replaced by a D/A converter 238′, and the data register circuit 223 and the data latch circuit 224 of FIG. 5 are replaced by a sample/hold circuit 229. In this case, the D/A converter 228′ has a similar configuration to the D/A converter 238 of FIG. 5 except that only three D/A sections for the 6-bit video signals R, G and B (=Dx2) are provided, thus remarkably reducing the size of the data line driver 2.

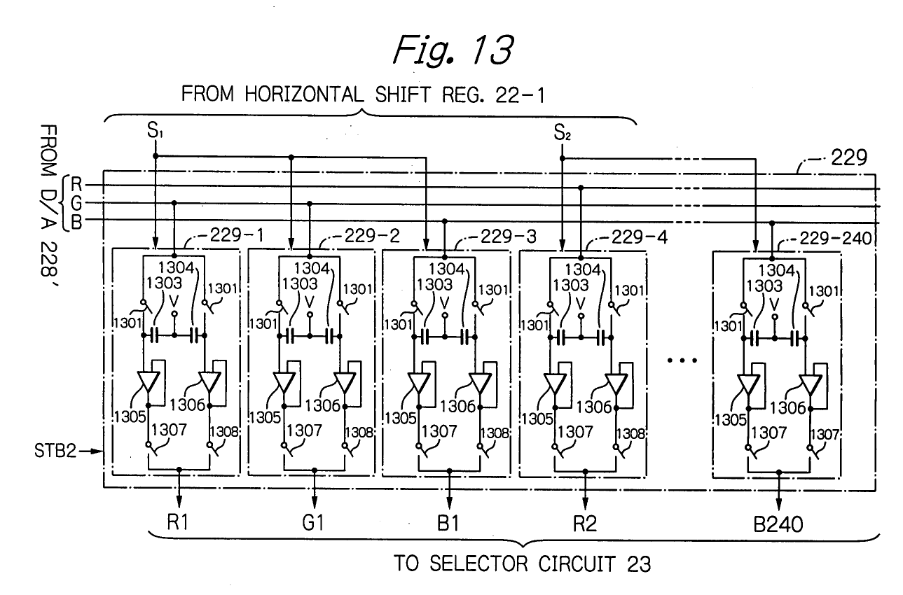

In FIG. 13, which is a detailed circuit diagram of the sample/hold circuit 229 of FIG. 12, the sample/hold circuit 229 is constructed by 720 sample/hold sections 229-1, 229-2, 229-3, 229-4, . . . , 229-720 each of which includes switches 3101 and 1302 controlled by one of the sample/hold signals S₁, S₂, . . . , S₂₄₀, capacitors 1303 and 1304, voltage amplifiers 1305 and 1306, and switches 1307 and 1308 controlled by the strobe signal STB2. Each of the sample/hold sections 229-1, 229-2, 229-3, 229-4, . . . , 229-720 is called a two-samples/two-amplifiers system.

The operation of the sample/hold circuit 229 of FIG. 13 is explained next. Here, assume that all the switches 1301, 1302, 1307 and 1308 are turned OFF.

When the sample/hold signal S₁ is supplied to the sample/hold circuit 229, the switches 1301 of the sample/hold sections 229-1, 229-2 and 229-3 are turned ON so that analog video signals R, G and B are stored in the capacitors 1303 of the sample/hold sections 229-1, 229-2 and 229-3, respectively, which is called a sampling operation. Then, the switches 1301 of the sample/hold sections 229-1, 229-2 and 229-3 are turned OFF, which is called a holding operation.

Next, when the sample/hold signal S₂ is supplied to the sample/hold circuit 229, the switches 1301 of the sample/hold sections 229-4, 229-5 and 229-6 are turned ON so that analog video signals R, G and B are stored in the capacitors 1303 of the sample/hold sections 229-1, 229-2 and 229-3, respectively, which is called a sampling operation. Then, the switches 1301 of the sample/hold sections 229-1, 229-2 and 229-3 are turned OFF, which is called a holding operation.

Finally, when the sample/hold signal S₂₄₀ is supplied to the sample/hold circuit 229, the switches 1301 of the sample/hold sections 229-718, 229-719 and 229-720 are turned ON so that analog video signals R, G and B are stored in the capacitors 1303 of the sample/hold sections 229-718, 229-719 and 229-720, respectively, which is called a sampling operation. Then, the switches 1301 of the sample/hold sections 229-718, 229-719 and 229-720 are turned OFF, which is called a holding operation.

Thus, when the strobe signal STB2 is supplied to the sample/hold circuit 229, the switches 1307 of all the sample/hold sections 229-1, 229-2, . . . , 229-720 are turned ON, so that the video signals stored in the capacitors 1303 of all the sample/hold circuit 229 are output as R1, G1, B1, R2, B240 to the selector circuit 23. Then, the switches 1307 of all the sample/hold sections 229-1, 229-2, , 229-720 are turned OFF.

Next, when the sample/hold signal S₁ is again supplied to the sample/hold circuit 229, the switches 1302 of the sample/hold sections 229-1, 229-2 and 229-3 are turned ON so that analog video signals R, G and B are stored in the capacitors 1304 of the sample/hold sections 229-1, 229-2 and 229-3, respectively, which is called a sampling operation. Then, the switches 1302 of the sample/hold sections 229-1, 229-2 and 229-3 are turned OFF, which is called a holding operation.

Next, when the sample/hold signal S₂ is again supplied to the sample/hold circuit 229, the switches 1302 of the sample/hold sections 229-4, 229-5 and 229-6 are turned ON so that analog video signals R, G and B are stored in the capacitors 1304 of the sample/hold sections 229-1, 229-2 and 229-3, respectively, which is called a sampling operation. Then, the switches 1302 of the sample/hold sections 229-1, 229-2 and 229-3 are turned OFF, which is called a holding operation.

Finally, when the sample/hold signal S₂₄₀ is again supplied to the sample/hold circuit 229, the switches 1302 of the sample/hold sections 229-718, 229-719 and 229-720 are turned ON so that analog video signals R, G and B are stored in the capacitors 1304 of the sample/hold sections 229-718, 229-719 and 229-720, respectively, which is called a sampling operation. Then, the switches 1302 of the sample/hold sections 229-718, 229-719 and 229-720 are turned OFF, which is called a holding operation.

Thus, when the strobe signal STB2 is again supplied to the sample/hold circuit 229, the switches 1308 of all the sample/hold sections 229-1, 229-2, . . . , 229-720 are turned ON, so that the video signals stored in the capacitors 1304 of all the sample/hold circuit 229 are output as R1, G1, B1, R2, B240 to the selector circuit 23. Then, the switches 1308 of all the sample/hold sections 229-1, 229-2, . . . , 229-720 are turned OFF.

In FIG. 13, sample/hold sections of a two-samples/one-amplifier system can be used as the sample/hold sections 229-1, 229-2, . . . , 229-720.

In the above-described embodiment, only one partial image is -displayed; however, a plurality of partial images can be displayed. In this case, the CPU generates start gate lines GSs and end gate lines GEs and transmits them to the signal processing circuit 4. Also, as occasion demands, a plurality of partial image memories can be provided, or a plurality of areas for partial images can be provided in the partial image memory 211.

Also, in the above-described embodiment, while the LCD panel 1 has m rows×n columns pixels, the partial image memory 211 has p(=m) rows×q(<n) columns pixels. However, the partial image memory 211 can have p(≦m) rows×q(<n) columns pixels.

The present invention can be applied to other display apparatuses than LCD apparatuses. Particularly, since the driving of organic EL apparatuses is the same as that of a normally-black LCD apparatuses, the present invention can be applied to organic EL apparatuses.

As explained hereinabove, according to the present invention, the partial image memory can be reduced in size, which would reduce the manufacturing cost.

1. A driver for driving a color-type display apparatus capable of displaying a partial display area of a display panel, where each pixel is formed by at least three color dots, comprising:
a partial image memory adapted to store video data for each pixel of said partial display area; and
a color designating circuit adapted to designate a color of letters of said partial display area designated by said video data.

2. The driver as set forth in claim 1, wherein said video data comprises 1-bit data.

3. The driver as set forth in claim 1, wherein said color designating circuit comprises:
a color setting register adapted to set the color of letters of said partial display area; and
a color selecting circuit adapted to select the color of letters of said partial display area in accordance with the color set in said color setting register when said video data shows letters of said partial display area.

4. The driver as set forth in claim 3, wherein said color setting register is further adapted to set a background color of said partial display area and a color of a non-display area of said display panel,
said color selecting circuit being further adapted to select the background color of said partial display area and the color of said non-display area in accordance with the colors set in said color setting register.

5. The driver as set forth in claim 4, wherein the background color of said partial display area is the same as that of said non-display area.

6. The driver as set forth in claim 5, wherein the background colors of said partial display area and said non-display area are one of white and black.

7. The driver as set forth in claim 4, wherein the color of letters of said partial display area, the background color of said partial display area and the color of said non-display area are different from each other.

8. The driver as set forth in claim 3, wherein said color setting register being adapted to set one color for every column of pixels of letters of said partial display area.

9. A driver for driving a color-type display apparatus capable of carrying out a partial displaying operation to display a partial display image of p rows×q columns pixels in a display panel of m rows×n columns pixels where p≦m and q<n, where each pixel is formed by at least three color dots, comprising:
a partial image memory adapted to store p x q×1-bit video data for said partial display area; and
a color designating circuit adapted to designate a color of letters of said partial display area designated by said video data.

10. The driver as set forth in claim 9, wherein said color designating circuit comprises:
a color setting register adapted to set the color of letters of said partial display area; and
a color selecting circuit adapted to select the color of letters of said partial display area in accordance with the color set in said color setting register when said video data shows letters of said partial display area.

11. A driver for driving a color-type display apparatus including a display panel, where each pixel is formed by at least three color dots, comprising:
a partial display control section adapted to display a partial display area of said display panel;
an entire display control section adapted to display an entire display area of said display panel; and
a selector circuit connected to said partial display control section and said entire display control section and adapted to select one of said partial display control section and said entire display control section in accordance with a partial display signal,
said partial display control section comprising:
a partial image memory adapted to store video data for each pixel of said partial display area; and
a color designating circuit adapted to designate a color of letters of said partial display area designated by said video data.

12. The driver as set forth in claim 11, wherein said video data comprises 1-bit data.

13. The driver as set forth in claim 11, wherein said color designating circuit comprises:
a color setting register adapted to set the color of letters of said partial display area; and
a color selecting circuit adapted to select the color of letters of said partial display area in accordance with the color set in said color setting register when said video data shows letters of said partial display area.

14. The driver as set forth in claim 13, wherein said color setting register is further adapted to set a background color of said partial display area and a color of a non-display area of said display panel,
said color selecting circuit being further adapted to select the background color of said partial display area and the color of said non-display area in accordance with the colors set in said color setting register.

15. The driver as set forth in claim 14, wherein the background color of said partial display area is the same as that of said non-display area.

16. The driver as set forth in claim 15, wherein the background colors of said partial display area and said non-display area are one of white and black.

17. The driver as set forth in claim 14, wherein the color of letters of said partial display area, the background color of said partial display area and the color of said non-display area are different from each other.

18. The driver as set forth in claim 13, wherein said color setting register being adapted to set one color for every column of pixels of letters of said partial display area.

19. The driver as set forth in claim 11, wherein said entire display control section comprises:
a data register circuit adapted to sequentially latch multi-bit video signals;
a gradation voltage generating circuit adapted to generate two-gradation voltages or multi-gradation voltages in accordance with said partial display signal; and
a digital/analog converter adapted to convert said multi-bit video signals into analog video signals in accordance with said multi-gradation voltage.

20. The driver as set forth in claim 11, wherein said entire display control section comprises:
a gradation voltage generating circuit adapted to generate two-gradation voltages or multi-gradation voltages in accordance with said partial display signal;
a digital/analog converter adapted to convert multi-bit video signals into analog video signals in accordance with said multi-gradation voltage; and
a sample/hold circuit adapted to sequentially sample and hold said analog video signals.
